(19) United States
(12) Patent Application Publication
(10) Pub. No.: US 2016/0036906 A1
(43) Pub. Date: Feb. 4, 2016

(54) DYNAMIC ADJUSTMENT OF CLIENT THICKNESS

(71) Applicant: Vixlet LLC, Los Angeles, CA (US)

(72) Inventor: Ajev AH Gopala, Manhattan Beach, CA (US)

(21) Appl. No.: 14/811,870

(22) Filed: Jul. 29, 2015

Related U.S. Application Data
(60) Provisional application No. 62/032,777, filed on Aug. 4, 2014.

(51) Int. Cl. H04L 29/08; G06F 15/167

(52) U.S. Cl. CPC H04L 67/1023; G06F 15/167

(57) ABSTRACT

Some embodiments relate generally to providing a dynamically adjustable client and server thickness. An apparatus can include at least one processor, at least one memory device, and at least one network interface module, and a segmented application stored in the at least one memory device and executable by the at least one processor, wherein the segmented application includes a first application segment comprising executable code stored locally to be executed by the at least one processor and a second application segment comprising a stub that when activated directs the processor to a location where at least one output variable of the second application segment is stored, wherein execution of the first application segment depends on the at least one output variable of the second application segment.

### RELATED APPLICATION

This application claims the benefit of priority to U.S. Provisional Patent Application No. 62/032,777, titled “Passion-Centric Networking” and filed Aug. 4, 2014, which is incorporated herein by reference in its entirety.

### BACKGROUND INFORMATION

Providing a user with a view of an application, such as a social network application, can be cumbersome in terms of the calculations that need to be performed and the amount of data to be displayed to a user. A load time of an application display is a function of a number of factors. Such factors can include how much data is to be displayed and the bandwidth of an item with the lowest bandwidth in a communication chain between a display device and a device performing operations of the application.

### BRIEF DESCRIPTION OF THE DRAWINGS

FIG. 1 illustrates a graph of server vs. client data and processing thickness.

FIG. 2 illustrates, by way of example, an embodiment of a system for dynamically adjusting which device of a client or a server performs operations and/or stores data to be used in providing application functionality.

FIG. 3A illustrates, by way of example, an embodiment of an application segmented so as to help allocate execution of the application to multiple devices (e.g., a client and a server).

FIG. 3B illustrates, by way of example, an embodiment of an application segmented so as to help allocate execution of the application to multiple devices.

FIG. 4 illustrates, by way of example, a communication diagram of an embodiment of the server requesting to handover execution of an application segment to the client.

FIG. 5 illustrates, by way of example, a communication diagram of an embodiment of the client requesting to handover execution of an application segment to the server.

FIG. 6 illustrates, by way of example, a flow diagram of an embodiment of a method of transferring execution of an application between devices.

FIG. 7 illustrates, by way of example, a flow diagram of an embodiment of a method for reducing execution complexity and/or reducing bandwidth required to execute an application.

FIG. 8 illustrates, by way of example, a logical block diagram of a capsule-based (e.g., content and/or passion-based) social networking system architecture.

FIG. 9 illustrates, by way of example, a block diagram of an embodiment of a device upon which any of one or more processes (e.g., techniques, operations, or methods) discussed herein can be performed.

### DETAILED DESCRIPTION

In the following detailed description, reference is made to the accompanying drawings that form a part hereof, and in which is shown by way of illustration specific embodiments in which the subject matter may be practiced. These embodiments are described in sufficient detail to enable those skilled in the art to practice them, and it is to be understood that other embodiments may be utilized and that structural, logical, and electrical changes may be made without departing from the scope of the subject matter. The following description is, therefore, not to be taken in a limited sense, and the scope of inventive subject matter is defined by the claims.

The functions or algorithms described herein are implemented in hardware, software, or a combination of software and hardware. The software comprises machine executable instructions stored on one or more non-transitory computer readable media, such as a memory or other type of storage devices. Further, described functions may correspond to modules, which may be software, hardware, firmware, or any combination thereof. One or more functions are performed in one or more modules as desired, as may vary between embodiments, and the embodiments described are merely examples. The software can be executed on a single or multi-core processor, such as a digital signal processor, application specific integrated circuit (ASIC), microprocessor, or other type of processor operating on one or more computing systems, such as a personal computer, mobile computing device (i.e., smartphone, tablet, automobile computer or controller), set-top-box, server, a router, or other device capable of processing data, such as a network interconnection device.

Some embodiments implement the functions (e.g., operations) in two or more specific interconnected modules or devices with related control and data signals communicated between and through the modules, or as portions of an application-specific integrated circuit. Thus, an embodiment of a process flow is applicable to software, firmware, and hardware implementations.

Many software applications include a client interacting with a server to provide at least some of the functionality of the application. The location of the data to perform the operations and the device (client or server) that is going to perform the operations is usually predetermined. However, a set rule on the location of the data and the device that performs the operations and/or stores the data may not be an efficient use of resources. It may be possible to speed up computation, such as by reducing data retrieval time and/or decreasing the time it takes to perform an operation, by dynamically adjusting which device performs the operations and/or where the data to perform the operations is stored.

The terms thick client and thin client (thin server and thick server) can be used in the context of processing and/or data. As used herein, the terms thick and thin client are used in terms of both. The phrase “thick client data” (i.e. “thin server data”) means that the client stores most of the data used to perform operations and the server stores a relatively small amount of the data, if any. The phrase “thick server data” (i.e. “thin client data”) means that the server stores most of the data used to perform operations and the client stores a relatively small amount of the data, if any. The phrase “thick client processing” (i.e. “thin server processing”) means that the client performs a majority of the operations used to provide the functionality of an application, while the server performs a relatively small amount of the operations, if any. The phrase “thick server processing” (i.e. “thin client processing”) means that the server performs a majority of the operations used to provide the functionality of an application, while the client performs a relatively small amount of the operations, if any.

In one or more embodiments, a client can perform operations on data that is stored on the server, such as by retrieving data from the server. Such a configuration requires the client to communicate with the server to retrieve data. Configurations that require such data access can include more downtime as compared to an application that operates from local data. This can be because, if the server experiences downtime, the application also experiences downtime, since the data required to perform the operations is on the server. In another example, the client can store data locally. Such a configuration requires the client to have sufficient memory and the processing hardware to perform the operations. An advantage of such an architecture is speed; since more data is local, the time lag between the client requesting data and performing an operation is reduced.

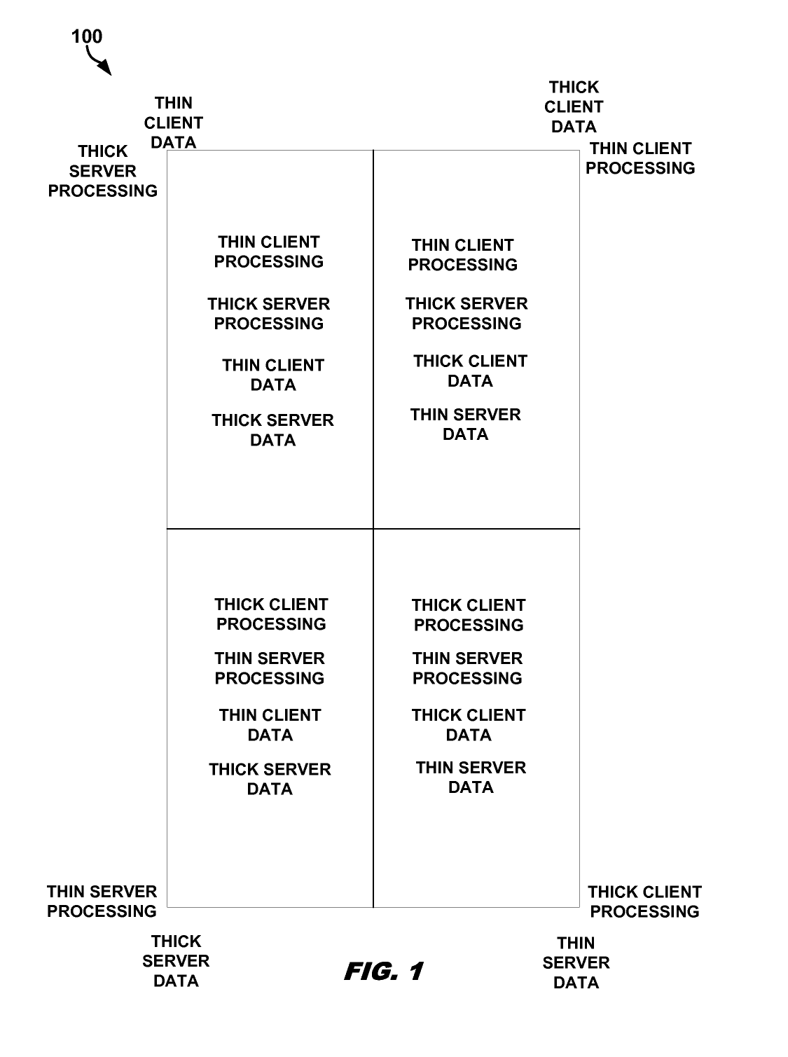

FIG. 1 illustrates a graph 100 of server vs. client data and processing thickness. An application operating in the upper left corner of the graph 100 includes the server performing all the processing and storing all the data for the application. In such embodiments, the server reports results to the client. An application operating in the lower right corner of the graph 100 includes the client performing all the processing and storing all the data for the application. Everywhere else on the graph 100, the processing and/or data is split between the server and the client. For example, an application operating in the upper right quadrant includes thin client processing (i.e. thick server processing) with thick client data (i.e. thin server data). In another example, an application operating in the lower left quadrant includes thick client processing (i.e. thin server processing) and thin client data (i.e. thick server data).

Some benefits of having thin client processing include simpler and/or cheaper hardware to perform the operations of the application. Updating the application with such a configuration is simpler than updating an application with thick client processing. In embodiments with thin client processing, the server may be updated to update the application with minimal, if any, update to the client. Whereas, with thick client processing, each client needs to be updated to update the functionality of the application.

In a thin client processing configuration, the client can be more secure, because the server performs the operations and is thus exposed to the malware therein without exposing the client to the malware. In a thin client processing and/or a thin client data configuration the client hardware can be cheaper than in a thick client processing or thick client data configuration, respectively. Some advantages of thick client processing and/or thick client data can include lesser server requirements, increased ability to work offline, better multimedia performance, and requiring less server bandwidth than a thin client processing and/or thin client data configuration.

The data can include program memory and one or more runtime files that may need to be loaded to perform an operation of the application, depending on the thinness or the thickness of the client. A runtime file is a file that is accessed by an application while the application is being executed. Runtime files can include an executable file, a library, a framework, or other file referenced by or accessed by the application during execution.

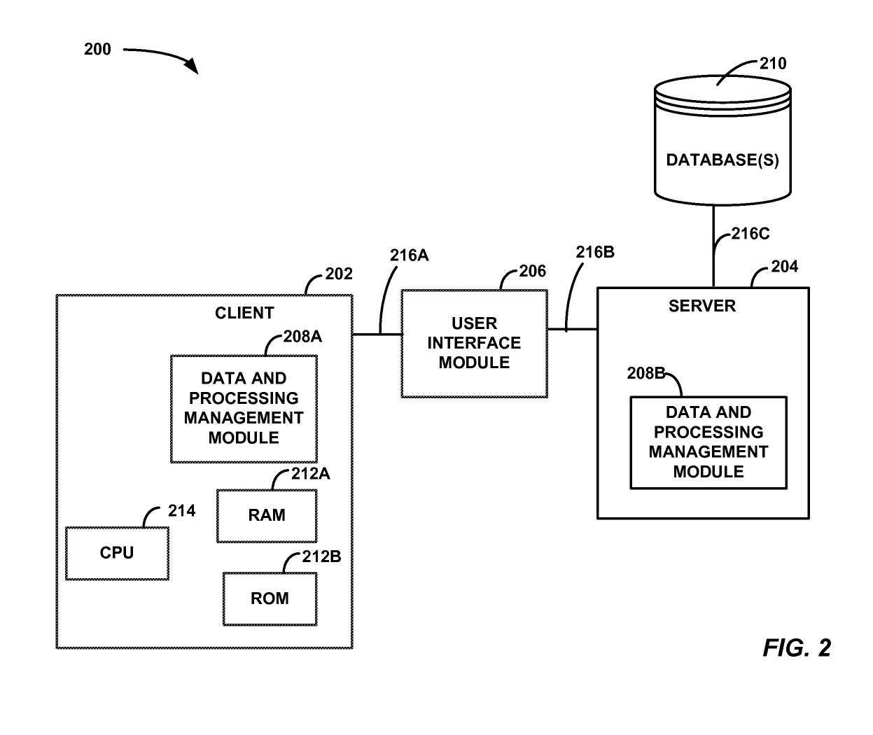

FIG. 2 illustrates, by way of example, an embodiment of a system 200 for dynamically adjusting which device of a client 202 or a server 204 performs operations and/or stores data to be used in providing application functionality. As illustrated, the system 200 includes the client 202 and the server 204 communicating through a user interface module 206 (e.g., a web server module). The client 202 and the server 204 are each communicatively coupled to one or more database(s) 210, such as can be local or remote for the server 204. The client 202 can include the local memory 212. Each of the client 202 and the server 204 can include a data and processing management module (DPMM) 208A and 208B, respectively.

The client 202 can include a tablet, smartphone, personal computer, such as a desktop computer or a laptop, set top box, in vehicle computer or controller, or other device. The client 202, as illustrated includes random access memory (RAM) 212A and read only memory (ROM) 212B resources available locally. The client includes a central processing unit (CPU) 214. The amount of RAM 212A, ROM 212B, and/or the speed of the CPU 214 can limit the ability of the client 202 to perform operations required to carry out the functionality of an application. The amount of RAM 212A, ROM 212B, and CPU 214 processing bandwidth (i.e. compute bandwidth) available at a given point in time is dependent on the current programs running on the client 202. At one time, the RAM 212A, ROM212B, and/or CPU 214 may not be used much, if at all, and the client 202 can be capable of executing (e.g., efficiently executing, such as without an appreciable lag from the perspective of a user) at least a portion of an application (e.g., one or more segments of the application). At another time, the RAM 212A, ROM 212B, and/or CPU 214 may be used to the point where the client 202 cannot perform operations (e.g., efficiently perform the operations) of the application.

The server 204 provides the functionality of an application server, such as by handling application operations between the client 202 and the database(s) 206 or a backend business application, such as can perform operations offline. The client 202 can access the database(s) 206 through the server 204.

The connections (represented by the lines 216A, 216B, and 216C) between the client 202, the server 204, and the database(s) 210 can limit the ability of the client 202 or the server 204 to efficiently perform operations of an application. Consider a configuration in which the server 204 is waiting for data from the client 202 and one or more of the communication connections between the client 202 and the server 204 is slow or broken. The server 204 needs to wait until it gets the data from the client 202 to finish performing its operations. The speed of the connection(s) between the client 202 and the server 204 can be considered (by the DPMM 208A-B) in determining how to allocate execution of the operations of the application.

The user interface (UI) module 206 can include a web server application that implements the Hypertext Transfer Protocol (HTTP). The UI module 206 serves data that forms web pages to the client 202. The UI module 206 forwards requests from the client 202 to the server 204 and vice versa. The module forwards responses to requests between the client 202 and the server 204.

The DPMM 208A can determine an available compute bandwidth of the client 202, a speed (e.g., baud rate, bit rate, or the like) of a connection between the client 202 and the server 204, and/or a received signal strength (RSS) of a signal from the server 204 (e.g., through the UI 206). The DPMM 208B can determine an available compute bandwidth of the server 204, a speed of a connection between the client 202 and the server 204, and/or an RSS of a signal from the client 202 (e.g., through the UI 206). The DPMM 208A-B can determine what resources of the application (e.g., executables, libraries, static data files, configuration files, log files, trace files, content files, or the like) are stored locally on the client 202 and the server 204, respectively.

The database(s) 210 include data stored in one or more of a variety of formats. The database(s) 210 can include a relational and/or a non-relational database A relational database can include a Structured Query Language (SQL) database, such as MySQL or other relational database. A non-relational database can include a document-oriented database, such as MongoDB. The database(s) 210 can store a runtime file and data (e.g., program memory or other data used by an application that is running on the client 202 and the server 204).

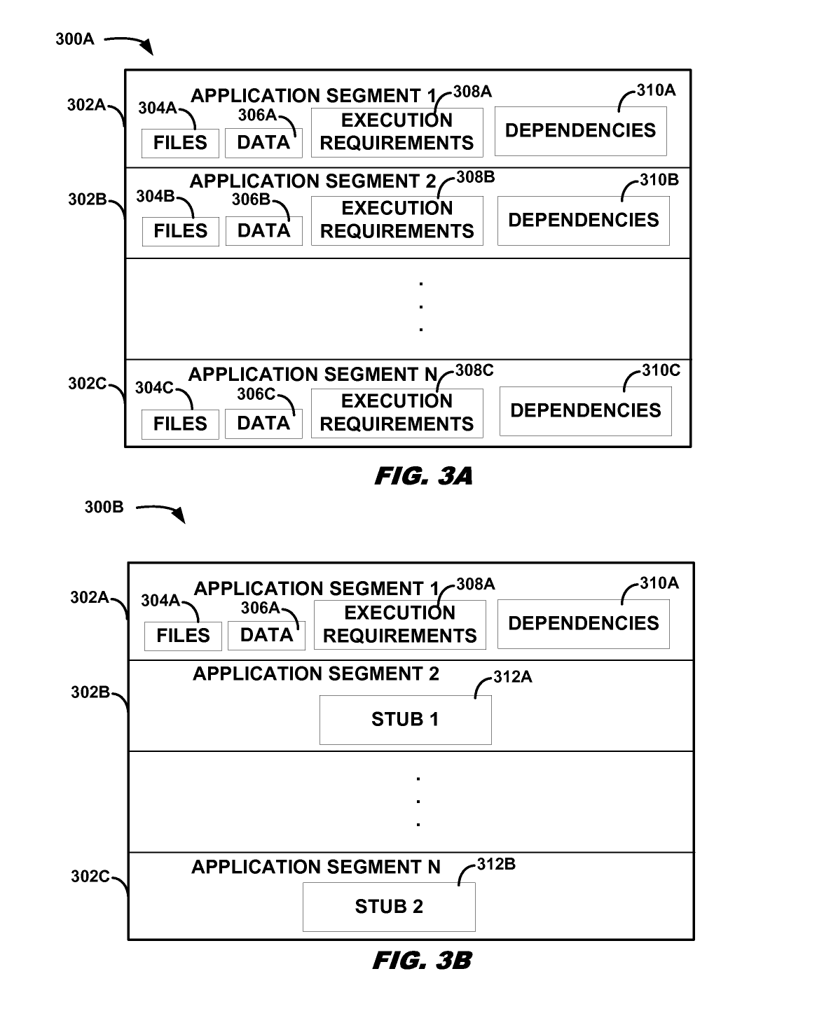

FIG. 3A illustrates, by way of example, an embodiment of an application 300A segmented so as to help allocate execution of the application 300A to multiple devices (e.g., the client 202 and the server 204). The application 300A as illustrated is split into application segments 302A, 302B, and 302C. Each segment 302A-C includes one or more files 304A, 304B, and 304C, data 306A, 306B, and 306C, execution requirements 308A, 308B, and 308C, and dependencies 310A, 310B, and 310C, respectively.

The files 304A-C include run time files and other files required to perform the operations of the application 300A. The files 304A-C can includes one or more executables, libraries, static data files, configuration files, log files, trace files, and/or content files or the like.

The data 306A can include an initial value for a variable, a value for a variable as determined by another application segment, and/or a link to where data required to perform one or more operations of the application segment 302A-C is located and can be retrieved.

The execution requirements 308A-C include details of the computer resources required to perform the operations of the application segment 302A-C (e.g., to run the application efficiently). The execution requirements 308A-C can include an amount of RAM, ROM, and/or compute bandwidth required to perform the operations of the application segment 302A-C. The execution requirements 308A-C can include a required RSS measurement for the client 202 to execute the segment 302A-C for a specific image/video resolution and/or whether the results of operating the segment 302A-C are to be streamed or cached. For example, consider an example in which the client 202 determines that the RSS is X, the client 202 can determine a category in which X falls in the execution requirements 308A-C. The execution requirements 308A-C can define that the RSS of X corresponds to a high, middle, or low video/image resolution, such as to allow the client 202 to provide the user with the best resolution possible, such as without compromising the runtime of the application by making the application lag from the perspective of the user.

The RAM and ROM requirements are the amount of each type of memory that is required to perform the operations of the segment 302A-C. The compute bandwidth is the minimum processing speed required, in operations (e.g., instructions) per unit time or other unit. The compute bandwidth of a device is a function of the overall compute speed of the device, accounting for the CPU speed and architecture constraints of performing operations on the device, the amount of processing that is currently being performed by the device, the type of instructions being executed, the execution order, and the like. Consider a processor that operates at three gigahertz (i.e. performs about 3×10̂9 instructions per second). If 90% of the processor operation is currently occupied by other applications, there remains only about 3×10̂8 instructions per second of compute bandwidth available for performing other application instructions.

The dependencies 310A-C include definitions of the inputs of the application segment 302A-C and outputs of the application segment 302A-C. The dependencies 310A-C can indicate where the input is from (the data 306A-C, another application segment 302A-C, or other location). Reducing the number of inputs that originate from another application segment 302A-C can help speed up the processing time of the application segment 302A-C (and the application overall), such as by reducing the lag time associated with waiting for or retrieving the input.

FIG. 3B illustrates, by way of example, an embodiment of an application 300B segmented so as to help allocate execution of the application 300A to multiple devices. The application 300B is similar to the application 300A with the application 300B including segments 302B and 302C that include stubs 312A and 312B, respectively. The stubs 312A-B indicate to the device performing the operations of the application 300B that another device is performing the operations, a location at which the device can retrieve the result(s) of the other device performing the operations, and/or where the device performing the application segment 302A can retrieve the files 304B-C, the data 306B-C, the execution requirements 308B-C, and/or the dependencies 310B-C are located, such that the device can download them and begin performing the operations of the application segment 302B-C. In one or more embodiments, the dependencies 310A can include a pointer to the same location, which is indicated by the stub 312A-B, or they can point to the location of the stub 312A-B that points to the data required to perform one or more of the operations of the application 300B.

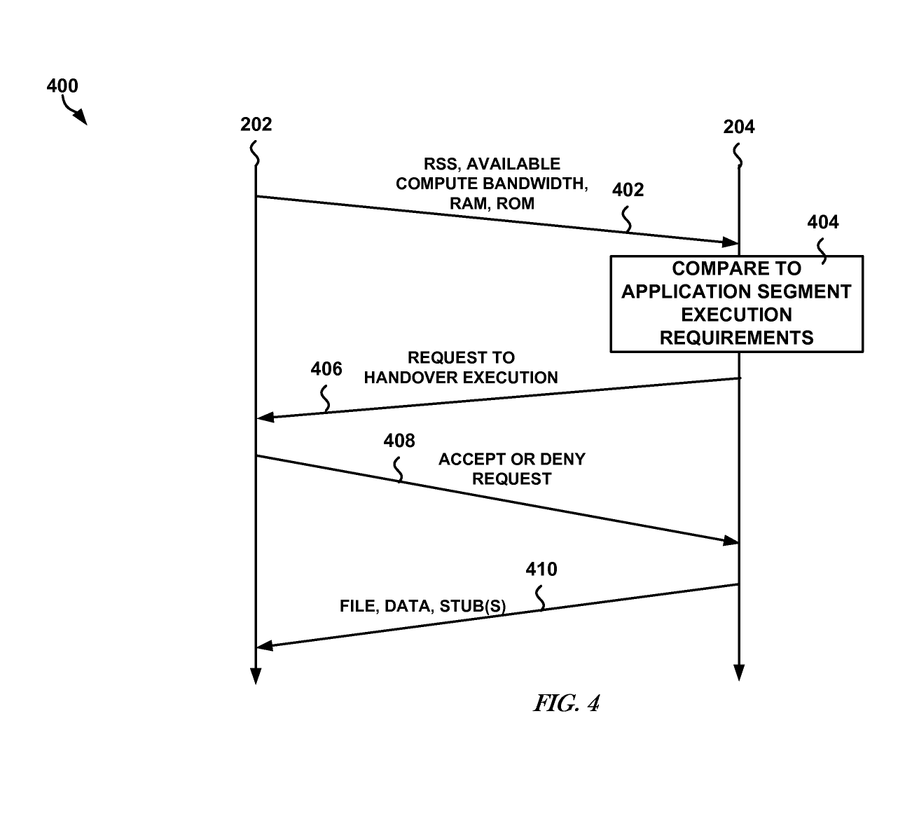

FIG. 4 illustrates, by way of example, a communication diagram 400 of an embodiment of the server 204 requesting to handover execution of an application segment to the client 202. At 402, the client 202 can communicate to the server 204 one or more execution parameters, such as can include RSS, available compute bandwidth, RAM, ROM, or other parameter on which execution may depend. At 404, the server compares received execution parameters required file(s) 304, data 306, stub(s) 312, and/or dependencies 310 to application segment execution requirements. In response to the server 204 determining that the received execution parameters are greater than or equal to the application segment execution requirements and/or the required file(s) 304, data 306, stub(s) 312, dependencies 310 for execution are available for the client 202, the server 204 can request to handover execution of one or more of the application segments to the client 202, at operation 406.

In one or more embodiments, the client 202 can accept or deny the request at operation 408. The client 202 generally denies the request if the application segment execution requirements exceed the execution parameters. The execution parameters are dynamic and subject to changing quickly. Thus, the execution parameters provided by the client 202 at operation 402 may no longer be accurate and have changed to the point where the client 202 may no longer have sufficient RSS, available compute bandwidth, RAM, ROM, or other parameter on which execution may depend to execute the application segment without an appreciable lag in execution. The client 202 can deny the request if the client 202 already has an item to be displayed stored locally, such as a photo, video, or other content, and does not need the server 204 to provide the content for execution of the segment.

In one or more embodiments, the client 202 can acknowledge that the server 204 is handing over execution of a segment of the application. At operation 410, the server 204 can transfer the required file(s) 304, data 306, stub(s) 312, dependencies 310, or other item used to execute the application segment. Alternatively, the server 204 can indicate to the client 202 where to retrieve the item(s) used to execute the application segment. In yet another embodiment, the client 202 can know in advance where to retrieve the item(s) used to execute the application segment 302A-C, such as by using the stub 312A-B. The operation at 410 will not occur if the client 202 denies the request at operation 408.

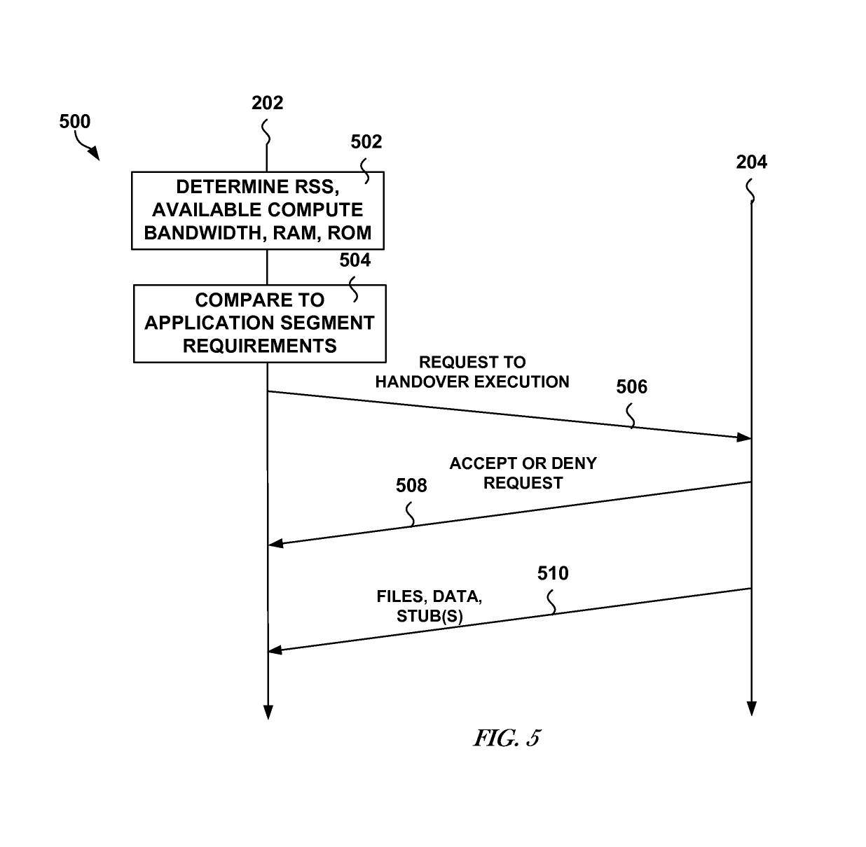

FIG. 5 illustrates, by way of example, a communication diagram 500 of an embodiment of the client 202 requesting to handover execution of an application segment to the server 204. At operation 502, the client 202 can determine RSS, available compute bandwidth, RAM, ROM, and/or other execution parameter of the client 202. At operation 504, the client 202 compares the determined execution parameter(s) to application segment execution requirements, such as can include a requires RSS, bandwidth, RAM, ROM, or other execution parameter required to execute an application segment. Other execution parameters can include a requires operating system, a bitness (e.g., 32 bit, 64 bit, 128 bit, or other bitness) of a processor and/or a make or model of a processor. In response to determining that the determined execution parameters are sufficient to allow the client 202 to execute one or more additional application segments, the client can request the server 204 to handover execution of the application segment at operation 506. The server 204 accepts or denies the request (or acknowledges that the client will be taking over execution of the application segment) at operation 508. The server 204 can deny the request if, for example, the client 202 recently (within a specified period of time) took over execution of the application segment or the server 204 determines that an application segment execution requirement is no longer satisfied by the execution parameters (e.g., the RSS is no longer sufficient to transfer execution).

At operation 510, the server 204 can transfer the required files, data, stub(s), dependencies, or other item used to execute the application segment 302A-C. Alternatively, the server 204 can indicate to the client 202 where to retrieve the item(s) used to execute the application segment 302A-C. In yet another embodiment, the client can know where to retrieve the item(s) used to execute the application segment, such as by using the stub 312A-B. The operation at 510 will not occur if the client 202 denies the request at operation 508.

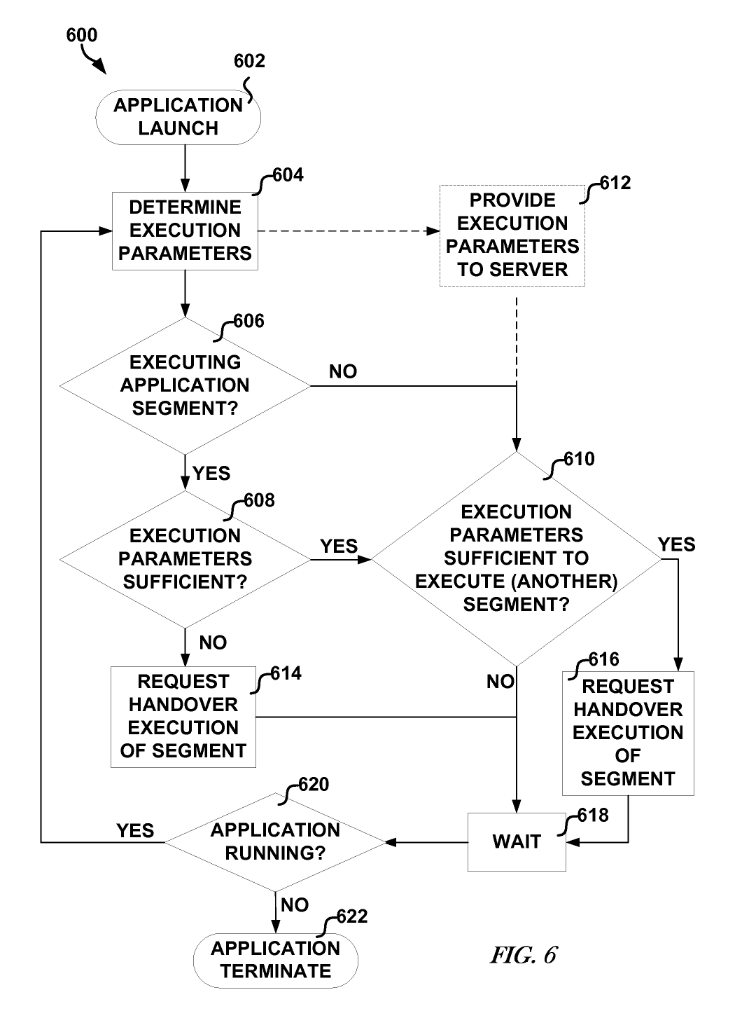

FIG. 6 illustrates, by way of example, a flow diagram of an embodiment of a method 600 of transferring execution of an application between devices. The method 600 begins at operation 602 with a launch of an application, such as the application 300A-B. At operation 604, one or more execution parameters are determined, such as by the client 202 and/or the server 204.

At operation 606, the client 202 and/or the server 204 can determine if they are currently executing, or responsible for executing, one or more application segments of the application. This operation can be performed by looking up which of the devices is responsible for the execution, such as in the database 210 or the RAM 212A. If the client 202 or the server is executing or responsible for executing the application segment, it can be determined if the execution parameters are sufficient to execute the application segment at operation 608.

At operation 610, it is determined if the execution parameters indicate that the device can execute (another) application segment. This operation can be performed after the execution parameters are provided to the server 204, such as at operation 612, the device determines that it is not currently executing, or responsible for executing, an application segment at operation 606, or the device is executing or responsible for executing an application and the execution parameters indicate that the device is capable of executing the segment it is currently responsible for executing.

If the execution parameters indicate that the device is not currently capable of performing the execution of the application segment at operation 608, then the device can request a handover of the execution of the application segment at operation 614. Similarly, if the device determines that it is capable of executing an application segment (another application segment) at operation 610, the device can request handover of the execution of a segment (another segment) at operation 616. Some examples of handover procedures are detailed in FIGS. 4 and 5.

At operation 618, the device can wait. The wait is optional and can be for a specified period of time (e.g., nanoseconds, microseconds, milliseconds, centiseconds, deciseconds, seconds, minutes, hours, days, etc.). After the wait period has expired, it can be determined if the application is running at operation 620. Alternatively, the method can include performing the operation at 616 and then performing the operation at 610. If the application is running, the method 600 can continue at operation 604. Since execution parameters are dynamic, determining the execution parameters periodically (with a wait) and comparing the execution parameters to the application segment execution requirements can help ensure that the application continues to run as smoothly as possible while keeping up with the changing conditions. If the application is no longer running, as determined at operation 620, the method 600 can end at operation 622, such as until the application launches and the method 600 continues again at operation 602.

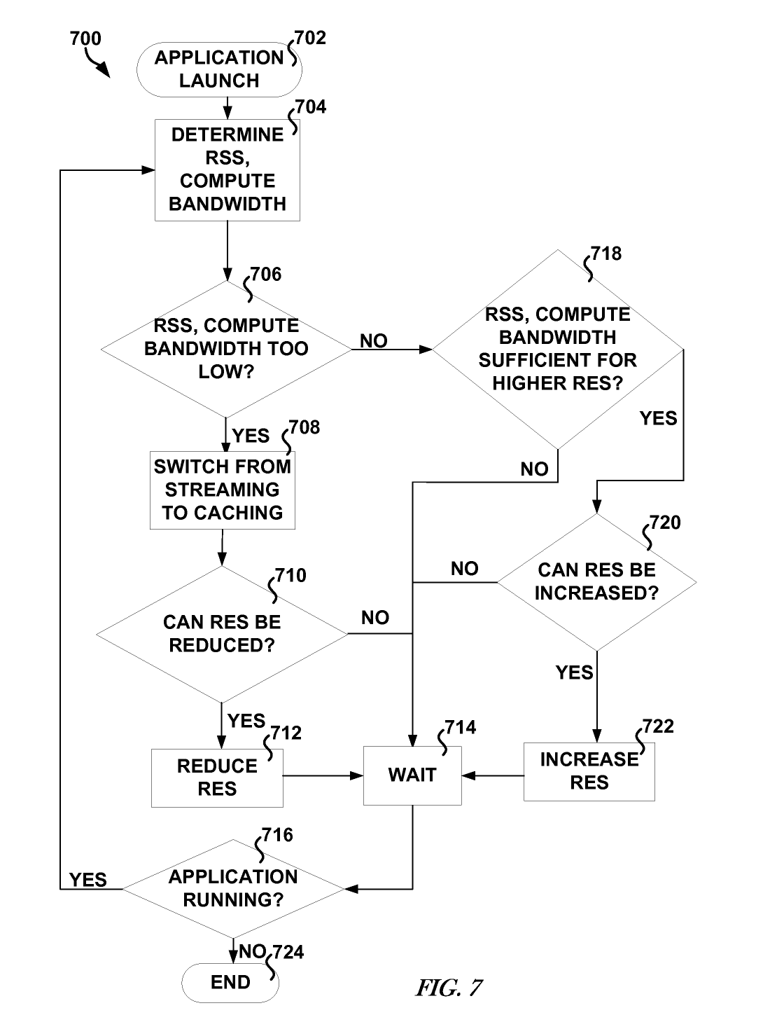

FIG. 7 illustrates, by way of example, a flow diagram of an embodiment of a method 700 for reducing execution complexity and or dealing with low bandwidth or signal strength. The method 700 can be used in conjunction with the method 600 or as a standalone method. The method 700 begins with an application launch at operation 702. At operation 704 RSS and/or compute bandwidth can be determined. At operation 706, it can be determined if the determined RSS and/or compute bandwidth are too low for sufficient execution of the application (e.g., execution without appreciable lag from the perspective of a user). If the RSS and/or the bandwidth is determined to be too low the execution of the application can optionally be switched from streaming to caching at operation 708. Caching includes saving changes (deltas) locally and transmitting the relevant changes to the other device when the RSS and/or compute bandwidth returns to being sufficiently high to switch back to streaming. Some devices may not have caching capability. In such a situation, the method 700 can continue at operation 710.

At operation 710, it can be determined if the resolution of video or image to be displayed on the client 202 can be reduced. If the resolution can be reduced (i.e. the resolution is not currently at the lowest supported resolution for the image or video) the image or video resolution is reduced at operation 712. For example, if the resolution of a video or image can be reduced from full high definition (HD) (1080p) to HD (720p), the video or image can be reduced to HD, such as to require less compute bandwidth to display and/or less bandwidth to download the image or video. In another example, a video or image can have its resolution reduced from HD to a quarter full HD or a ninth full HD, or other resolution.

The operations at 714 and 716 are the same as the operations 618 and 620, respectively, with the operation at 714 being performed in response to determining the RSS or compute bandwidth is not too low at operation 706, determining the resolution cannot be reduced at operation 710, or reducing the resolution at operation 712. At operation 718, if the RSS and/or compute bandwidth is determined to be too low, it can be determined if the RSS and/or compute bandwidth is sufficient to support a higher resolution image or video, such as without significantly affecting the performance of the application (e.g., without hindering the user experience, such as by having an appreciable lag in the display of the application to the user). If the RSS and/or compute bandwidth is sufficient to support a higher resolution image or video, it can be determined if the resolution of the image or video used in the execution of the application can be increased at operation 720. If the resolution can be increased (i.e. the resolution is not currently maximized), the resolution is increased at operation 722. If there is insufficient RSS and/or compute bandwidth to support a higher resolution or the resolution cannot be increased from its current resolution, the method continues at operation 714 with an optional wait time. The method 700 terminates at 724 when it is determined that the application is no longer running at operation 716.

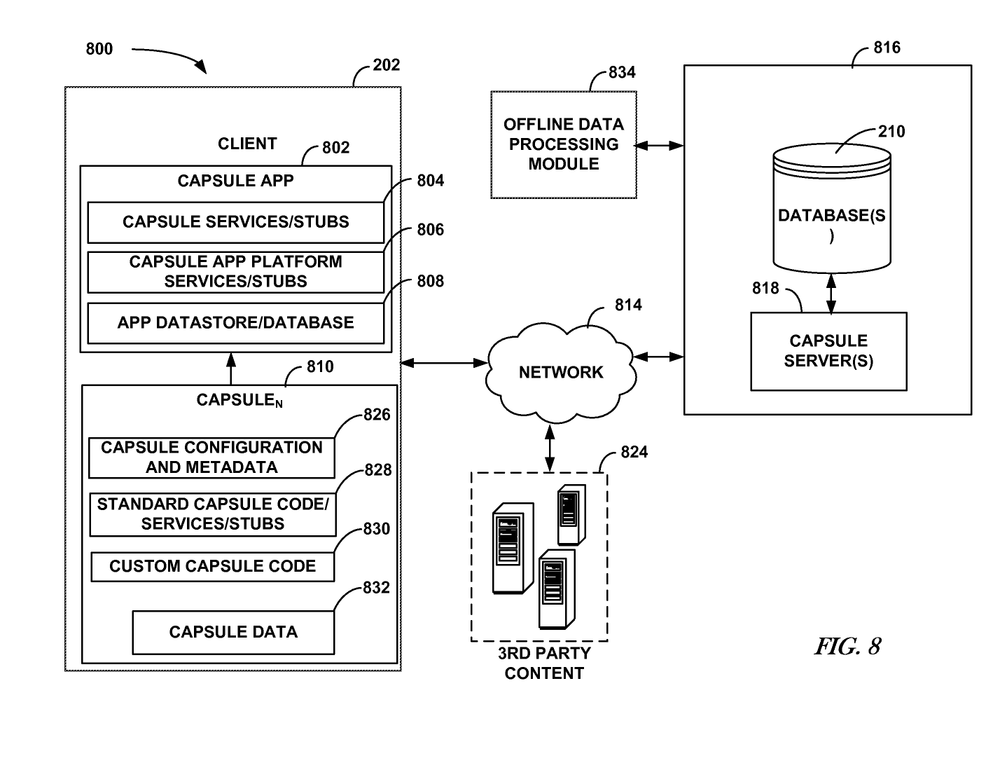

FIG. 8 illustrates, by way of example, a logical block diagram of a capsule-based (e.g., content and/or passion-based) social networking system 800 architecture. The system 800 as illustrated includes a passion-centric networking backend system 816 connected over a network 814 to the client 202. Also connected to the network 814 are third party content providers 824 and/or one or more other system(s) and entities that may provide data of interest to a particular capsule or passion. A passion is generally defined by one or more capsules and the user interaction with the content of the capsules.

A third party content provider 824 may include corporate computing systems, such as enterprise resource planning, customer relationship management, accounting, and other such systems that may be accessible via the network 814 to provide data to client 202. Additionally, the third party content providers 824 may include online merchants, airline and travel companies, news outlets, media companies, and the like. Content of such third party content providers 824 may be provided to the client 202 either directly or indirectly via the system 816, to allow viewing, searching, and purchasing of content, products, services, and the like that may be offered or provided by a respective third party content provider 824.

The system 816 includes a web and app computing infrastructure (i.e., web server(s), application server(s), data storage, database(s), data duplication and redundancy services, load balancing services). The illustrated system 816 includes at least one capsule server 818 and database(s) 210. The server 204 can include one or more capsule server(s) 818. The capsule server 818 is a set of processes that may be deployed to one or more computing devices, either physical or virtual, to perform various data processing, data retrieval, and data serving tasks associated with capsule-centric networking. Such tasks include creating and maintaining user accounts with various privileges, serving data, receiving and storing data, and other platform level services. The capsule server 818 may also offer and distribute apps, applications, and capsule content such as through a marketplace of such items. The capsule app 802 is an example of such an app. Data and executable code elements of the system 816 may be called, stored, referenced, or otherwise manipulated by processes of the capsule server 818 and stored in the database(s) 210.

The client 802 interacts with the system 816 and the server 818 via the network 814. The network 814 may include one or more networks of various types. The types may include one or more of the Internet, local area networks, virtual private networks, wireless networks, peer-to-peer networks, and the like.

In some embodiments, the client 202 interacts with the system 816 and capsule server 818 over the network 814 via a web browser application or other app or application deployed on the client 202. In such embodiments, a user interface, such as a web page, can be requested by a client web browser from the system 816. The system 816 then provides the user interface or web page to the client web browser. In such embodiments, executable capsule code and platform services are essentially all executed within the system 816, such as on the server 818 or other computing device, physical or virtual, of the system 816.

In some other embodiments, the client 202 interacts with the system 816 and the server 818 over the network 814 via an app or application deployed to the client 202, such as the app 802. The app or application may be a thin or thick client app or application, the thickness or thinness of which may be dynamic.

The app 802 is executable by one or more processors of the client 202 to perform operation(s) on a plurality of capsules (represented by the capsule 810). The capsule app 802, in some embodiments is also or alternatively a set of one or more services provided by the system 816, such as the capsule server 818.

The capsule app 802 provides a computing environment, tailored to a specific computing device-type, within which one or more capsules 810 may exist and be executed. Thus, there may be a plurality of different capsule apps 802 that are each tailored to specific client device-types, but copies of the same capsules 810 are able to exist and execute within each of the different capsule apps 802 regardless of the device-type.

The capsule app 802 includes at least one of capsule services and stubs 804 that are callable by executable code or as may be referenced by configuration settings of capsules 810. The capsule app 802 also provides a set of platform services or stubs 806 that may be specific just to the capsule app 802, operation and execution thereof, and the like. For example, this may include a graphical user interface (GUI) of the capsule app 802, device and capsule property and utilization processes to optimize where code executes (on the client device or on a server) as discussed above, user preference tracking, wallet services, such as may be implemented in or utilized by the capsules 810 to receive user payments, and the like. The capsule app 802 also includes at least one of an app data store and database 808 within which the capsule app 802 data may be stored, such as data representative of user information and preferences(e.g., capsule availability data and/or attribute(s)), configuration data, and capsule 810.

The capsule 810 may include a standardized data structure form, in some embodiments. For example, the capsule 810 can include configuration and metadata 826, capsule code/services/stubs 828, custom capsule code 830 and capsule data 832.

The capsule configuration and metadata 826 generally includes data that configures the capsule 810 and provides descriptive data of a passion or passions for which the respective capsule 810 exists. For example, the configuration data may switch capsule 810 on and off within the capsule 810 or with regard to certain data types (e.g., image resolutions, video resolution), data sources (e.g., user attributes or certain users or certain websites generally, specific data elements), locations (e.g., location restricted content or capsule access) user identities (i.e., registered, authorized, or paid users) or properties (i.e., age restricted content or capsule), and other features of the capsule 810.

The standard capsule code/services/stubs 828 includes executable code elements, service calls, and stubs that may be utilized during execution of the capsule 810. The standard capsule code/services/stubs 828 in some capsules may be overridden or extended by custom capsule code 830.

Note that stubs, as used herein, are also commonly referred to as method stubs. Stubs are generally a piece of code that stands-in for some other programming functionality. When stubs are utilized herein, what is meant is that an element of code that may exist in more than one place, a stub is utilized to forward calls of that code from one place to another. This may include instances where code of a capsule 810 exists in more than one instance within a capsule or amongst a plurality of capsules 810 deployed to a computing device. This may also include migrating execution from a capsule 810 to a network location, such as the client 202 or the system 816. Stubs may also be utilized in capsules 810 to replace code elements with stubs that reference an identical code element in the capsule app 802 to which the capsule 810 is deployed.

A stub generally converts parameters from one domain to another domain so as to allow a call from the first domain (e.g., the client) to execute code in a second domain (e.g., the server) or vice versa. The client and the server use different address spaces (generally) and can include different representations of the parameters (e.g., integer, real, array, object, etc.) so conversion of the parameters is necessary to keep execution between the devices consistent. Stubs can provide functionality with reduced overhead, such as by replacing execution code with a stub. Stubs can also help in providing a distributed computing environment.

Capsules 810 provide a way for people and entities to build content-based networks to which users associate themselves. Programmers and developers enable this through creation of capsules 810 that are passion-based and through extension of classes and objects to define and individualize a capsule 810. Such capsules provide a way for people who have a passion, be it sports, family, music, entertainment to name a few to organize content related to the passion in specific buckets, referred to as capsules.

Capsules 810, which can also be considered passion channels, come with built-in technology constructs, also referred to as features, for various purposes. For example, one such feature facilitates sharing and distribution of various content types, such as technology that auto converts stored video content from an uploaded format to High Definition or Ultra High Definition 4K, to lower resolutions, or to multiple resolutions that can be selected based on a user's network connection speed and available server bandwidth. In some embodiments, capsules may also allow content to be streamed from a capsule to any hardware or other capsules.

Features are generally configurable elements of a capsule 810 instance. The configurable elements may be switched on and off during creation of a capsule 810 instance. Code elements of capsules 810 that implement to features may be included in a class or object from which a capsule 810 instance is created. In some embodiments, the code may be present in the capsule 810 instance, while in other embodiments, the feature-enabling code may be present in capsule apps 802. Other embodiments include feature-enabling code in whole or in part in capsule 810 instances, in the capsule app 802, and/or in a capsule server 818 that is callable by one or both of capsules 810 and the capsule app 802.

The capsule features include social technology in some embodiments, such as status sharing, commenting on post(s), picture and video uploading and sharing, event reminder (e.g., birthdays, anniversaries, milestones, or the like), chat, and the like. As the social feature is centralized around a passion of the particular capsule 810, the social features are shared amongst a self-associated group of users sharing a passion rather than simply people the user knows. Social sharing is therefore of likely relevance and interest to most users sharing that same passion as opposed to a post to a current social media network on a topic that may be of interest to only a select few of the users connections.

When a capsule icon is selected, content associated with the capsule represented by the selected icon will be presented, such as through a display of the client 202. When a user decides to add a capsule to a capsule app 802 or application, the user may be prompted to define the conditions regarding the availability and longevity of at least a portion of the content of the capsule.

Some capsules may also include a capsule edit feature that allows users to add, delete, and/or change some or all features of a capsule 810, such as can be determined by the permissions of the capsule. A user that creates a capsule can define who is allowed to add, change, and/or remove content from a capsule, post, comment, like, or otherwise interact with the content of the capsule. In this manner, the creator of the capsule can be responsible for being an admin of the capsule. This may allow a user to modify a passion definition of the capsule 810 such as by broadening or narrowing metadata defining the passion, adding or removing data sources from which passion-related content is sourced, and the like.

The data processing module 834 performs one or more operations offline, such as to populate one or more entries in the database 210. The data processing module 834 can mine data, perform data analysis, such as to determine a passion of a user, and/or alter data that populates the capsule 810. The data processing module 834 can infer or otherwise perform data analysis by crawling data on the internet, a website, a database, or other data source. As used herein “offline” means that whether the application is currently being executed is irrelevant, such that the item operates independent of the state of the application.

In one or more embodiments, the client 202 interacts with the system and the capsule server 218 over the network 814 via the app 802 or application deployed to the client device 202. The app 802 or application may be a thin or thick client app or application. While the difference between a thin and thick client app or application may be imprecise, the general idea is that some apps and applications include or perform a lesser (thinner) or greater (thicker) amount of processing and store a lesser (thinner) or greater (thicker) amount of capsule content and data. When functions and content accessed within the client 202 and the app 802 or application is not present on or not configured to execute within the app or application or on the client 202, the functions and content are accessed across the network 814 at the system 816 or from third party content providers 824.

In some embodiments, the thin and thick nature of a client device 202 app or application may be dynamically adjusted as previously discussed. Such dynamic adjustments may be made by a capsule platform service either independently or through interaction with one or more services of the system 816 based on client 202 properties. These properties may include data elements such as a device type and model, processor speed and utilization, available memory and data storage, graphic and audio processing capabilities, or other properties. As such client 202 properties can change over time. The DPMM 208A-B monitors these or other properties on the client 202 and determines a capsule deployment schema based and logical services of a capsule application on the client 202 or that may be called over the network 814 on the system 816.

When a capsule deployment schema has been determined, any changes to implement the determined capsule deployment schema are then implemented. This may include manipulating client device 202 configuration data, replication or removal of executable code and data objects to or from the client 202, replacing executable code with stubs that call executable code over a network, and the like. In some embodiments, some executable code and data object calls are made locally within the client 202 app or application with reference to data stored in a data structure, such as the database 210. The stored data with regard to an executable code or data object may include data of a function call or data retrieval request to be executed. The function call or request may to a locally stored object or be stub that receives arguments but when called, passes those arguments to a web service, remote function, or other call-type over the network 814 to effect the call or retrieval.

Thus, the elements of a capsule app 802 or application deployed to a client 202 may be dynamically changed. To support these dynamic changes, capsule and capsule apps and applications are built on an architecture of executable code and data objects that are stored by or on the system 816, third party content providers 824, and the client 202. The app or application deployed to the client 202 then determines where to access executable code and data objects via configuration data such as described herein. Such an architecture can make the dynamic changes on a client 202 transparent to the user with a goal of optimizing the user experience with regard to latency and/or client 202 utilization.

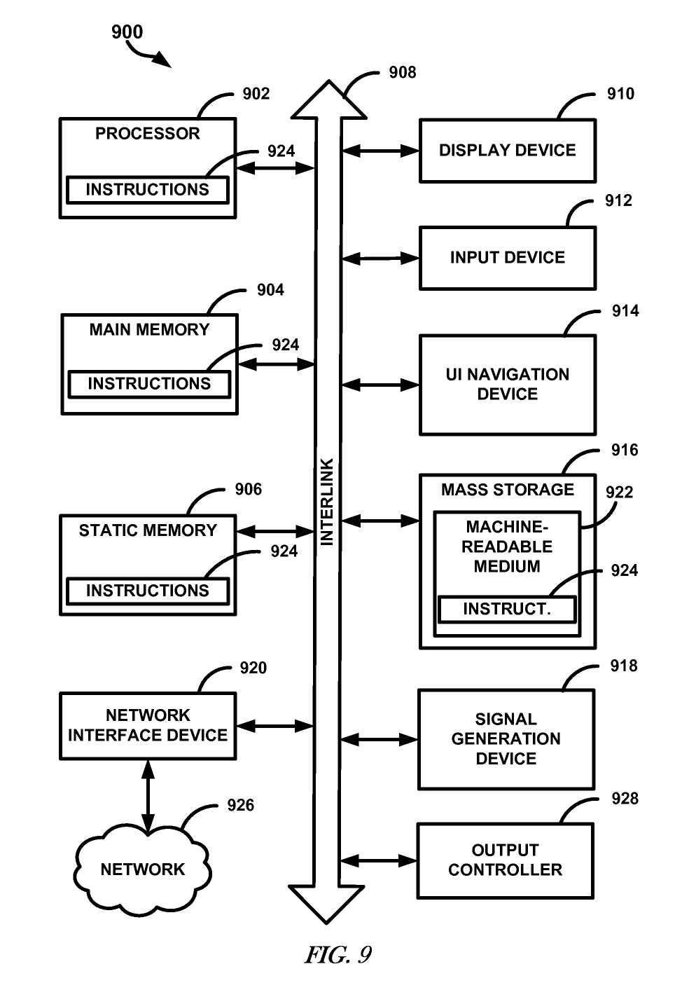

FIG. 9 illustrates, by way of example, a block diagram of an embodiment of a device 900 upon which any of one or more processes (e.g., techniques, operations, or methods) discussed herein can be performed. The device 900 (e.g., a machine) can operate so as to perform one or more of the programming or communication processes (e.g., methodologies) discussed herein. In some examples, the device 900 can operate as a standalone device or can be connected (e.g., networked) to one or more items of the system 200 or 800, such as the client 202, the server 204, the UI module 206, the DPMM 208A-B, the database(s) 210, the RAM 212A, the ROM 212B, the CPU 214, the client app 802, the capsule 810, the third party content server 824, the network 814, the system 816, the capsule server(s) 818, and/or the offline data processing module 834. An item of the system 200 or 800 can include one or more of the items of the device 900. For example one or more of the client 202, the server 204, the UI module 206, the DPMM 208A-B, the database(s) 210, the RAM 212A, the ROM 212B, the CPU 214, the client app 802, the capsule 810, the third party content server 824, the network 814, the system 816, the capsule server(s) 818, and/or the offline data processing module 834can include one or more of the items of the device 900.

Embodiments, as described herein, can include, or can operate on, logic or a number of components, modules, or mechanisms. Modules are tangible entities (e.g., hardware) capable of performing specified operations when operating. A module includes hardware. In an example, the hardware can be specifically configured to carry out a specific operation (e.g., hardwired). In an example, the hardware can include processing circuitry (e.g., transistors, logic gates (e.g., combinational and/or state logic), resistors, inductors, switches, multiplexors, capacitors, etc.) and a computer readable medium containing instructions, where the instructions configure the processing circuitry to carry out a specific operation when in operation. The configuring can occur under the direction of the processing circuitry or a loading mechanism. Accordingly, the processing circuitry can be communicatively coupled to the computer readable medium when the device is operating. For example, under operation, the processing circuitry can be configured by a first set of instructions to implement a first module at one point in time and reconfigured by a second set of instructions to implement a second module.

Device (e.g., computer system) 900 can include a hardware processor 902 (e.g., a central processing unit (CPU), a graphics processing unit (GPU), a hardware processor core, processing circuitry (e.g., logic gates, multiplexer, state machine, a gate array, such as a programmable gate array, arithmetic logic unit (ALU), or the like), or any combination thereof), a main memory 904 and a static memory 906, some or all of which can communicate with each other via an interlink (e.g., bus) 908. The device 900 can further include a display unit 910, an input device 912 (e.g., an alphanumeric keyboard), and a user interface (UI) navigation device 914 (e.g., a mouse). In an example, the display unit 910, input device 912 and UI navigation device 914 can be a touch screen display. The device 900 can additionally include a storage device (e.g., drive unit) 916, a signal generation device 918 (e.g., a speaker), and a network interface device 920. The device 900 can include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 can include a machine readable medium 922 on which is stored one or more sets of data structures or instructions 924 (e.g., software) embodying or utilized by any one or more of the techniques or functions described herein. The instructions 924 can also reside, completely or at least partially, within the main memory 904, within static memory 906, or within the hardware processor 902 during execution thereof by the device 900. In an example, one or any combination of the hardware processor 902, the main memory 904, the static memory 906, or the storage device 916 can constitute machine-readable media.

While the machine-readable medium 922 is illustrated as a single medium, the term “machine readable medium” can include a single medium or multiple media (e.g., a centralized or distributed database, and/or associated caches and servers) configured to store the one or more instructions 924. The term “machine readable medium” can include any tangible medium that is capable of storing, encoding, or carrying instructions for execution by the device 900 and that cause the device 900 to perform any one or more of the techniques (e.g., processes) of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media can include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks. A machine-readable medium does not include signals per se.

The instructions 924 can further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 920 can include one or more physical jacks (e.g., Ethernet, coaxial, or phone jacks) or one or more antennas to connect to the communications network 926. In an example, the network interface device 920 can include a one or more antennas coupled to a radio (e.g., a receive and/or transmit radio) to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the device 900, and includes digital or analog communications signals or other intangible medium to facilitate communication of such software.

### Additional Notes and Examples

The present subject matter can be described by way of several examples.

Example 1 can include or use subject matter (such as an apparatus, a method, a means for performing acts, or a machine readable medium including instructions that, when performed by the machine, can cause the device to perform acts), such as can include or use at least one processor, at least one memory device, and at least one network interface module, and a segmented application stored in the at least one memory device and executable by the at least one processor, wherein the segmented application includes a first application segment comprising executable code stored locally to be executed by the at least one processor and a second application segment comprising a stub that when activated directs the processor to a location where at least one output variable of the second application segment is stored, wherein execution of the first application segment depends on the at least one output variable of the second application segment.

Example 2 can include or use, or can optionally be combined with the subject matter of Example 1, to include or use a network interface device coupled to the at least one processor, and a data and processing management module (DPMM) coupled to the at least one processor, the DPMM determines one or more execution parameters of the at least one processor, the at least one memory device, and the network interface device and determines whether to handover execution of the first application segment to a processing device and whether to request to take over execution of the second application segment based on the determined execution parameters.

Example 3 can include or use, or can optionally be combined with the subject matter of Example 2 to include or use, wherein the execution parameters include available RAM of a first memory of the at least one memory, available ROM of a second memory of the at least one memory, available compute bandwidth of the at least one processor, and the RSS at the network interface device, and compares them to respective RAM, ROM, compute bandwidth, and RSS required for execution of the first application segment to determine whether to handover over execution of the first application segment to the processing device or retain execution of the first application segment.

Example 4 can include or use, or can optionally be combined with the subject matter of at least one of Examples 2-3 to include or use, wherein the execution parameters include available RAM of a first memory of the at least one memory, available ROM of a second memory of the at least one memory, compute bandwidth of the at least one processor, and the RSS at the network interface device, the network interface device provides the determined execution parameters to the processing device, and the network interface device receives a request to handover execution of the first application segment to the processing device.

Example 5 can include or use, or can optionally be combined with the subject matter of at least one of at least one of Examples 2-4 to include or use, wherein the execution parameters include available RAM of a first memory of the at least one memory, available ROM of a second memory of the at least one memory, compute bandwidth of the at least one processor, and the RSS at the network interface device, the network interface device provides the determined execution parameters to the processing device, and the network interface device receives a request to handover execution of the second application segment to the apparatus.

Example 6 can include or use, or can optionally be combined with the subject matter of at least one of Examples 2-5 to include or use, wherein the DPMM determines that at least one of the compute bandwidth or the RSS does not meet the execution requirements of the first application segment, the DPMM determines whether the resolution of an image or video is currently minimized, and the DPMM provides an indication to the at least one processor that causes the produce to reduce a resolution of an image or video upload or download in response to determining that at least one of the compute bandwidth and the RSS does not meet the execution requirements of the first application segment and determining that the resolution of the image or video is currently not minimized.

Example 7 can include or use, or can optionally be combined with the subject matter of at least one of Examples 2-6 to include or use, wherein the DPMM determines that the RSS does not meet the execution requirements of the first application segment, and the DPMM provides an indication to the at least one processor that causes the processor to begin storing deltas in a cache of the at least one memory for transmission to the processing device after the RSS is determined by the DPMM to meet the execution requirements.

Example 8 can include or use, or can optionally be combined with the subject matter of at least one of Examples 2-7 to include or use, wherein the DPMM determines the execution parameters periodically and determines whether to request to handover execution of the first application segment to the processing device in response to determining the execution parameters.

Example 9 can include or use, or can optionally be combined with the subject matter of at least one of Examples 2-8 to include or use, wherein the at least one memory includes at least one image or video of the first application segment thereon, the DPMM determines whether the resolution of the image or video stored on the at least one memory is maximized, and the DPMM requests a higher resolution version of the image or video from the processing device in response to determining the resolution of the image or video stored on the at least one memory is not maximized and the execution parameters are sufficient for the resolution.

Example 10 can include or use, or can optionally be combined with the subject matter of at least one of Examples 2-9 to include or use, wherein the DPMM determines the compute bandwidth and the RSS periodically and determines whether to increase or decrease the resolution of an image or video based on the determined compute bandwidth and the RSS and in response to determining the compute bandwidth and the RSS.

Example 11 can include or use subject matter (such as an apparatus, a method, a means for performing acts, or a machine readable medium including instructions that, when performed by the machine, can cause the device to perform acts), such as can include or use determining, using processing circuitry, a segmented application has launched, the segmented application including a first application segment comprising executable code stored locally to be executed by a local processor and a second application segment comprising a stub that when activated directs the local processor to a location where at least one output variable of the second application segment is stored, wherein execution of the first application segment depends on the at least one output variable of the second application segment, and in response to determining the segmented application has launched, determining, using a data and processing management module executable by the processing circuitry, one or more execution parameters of the at least one processor, at least one local memory device, and a network interface device, determining whether to handover execution of the first application segment to a processing device based on the determined execution parameters, and determining whether to request to take over execution of the second application segment based on the determined execution parameters.

Example 12 can include or use, or can optionally be combined with the subject matter of Example 11 to include or use, wherein the execution parameters include available RAM of a first memory of the at least one memory, available ROM of a second memory of the at least one memory, available compute bandwidth of the at least one processor, and the RSS at the network interface device, and the method further comprises, and comparing the determined execution parameters to respective RAM, ROM, compute bandwidth, and RSS required for execution of the first application segment to determine whether to handover over execution of the first application segment to the processing device or retain execution of the first application segment.

Example 13 can include or use, or can optionally be combined with the subject matter of at least one of Examples 11-12 to include or use, wherein determining the one or more execution parameters of the processing circuitry, at least one local memory device, and a network interface device, includes determine the one or more execution parameters periodically, determining whether to handover execution of the first application segment to a processing device based on the determined execution parameters includes determining whether to handover execution of the first application segment in response to determining the one or more execution parameters, and determining whether to request to take over execution of the second application segment based on the determined execution parameters includes determining whether to request to take over execution of the second application segment in response to determining the one or more execution parameters.

Example 14 can include or use, or can optionally be combined with the subject matter of at least one of Examples 11-13 to include or use determining, using the DPMM, that at least one of the compute bandwidth or the RSS does not meet the execution requirements of the first application segment for a current image or video resolution, determining, using the DPMM, whether the image or video resolution is currently minimized, and providing, using the DPMM, an indication to the processing circuitry that causes the processing circuitry to execute the first application segment using an image or video with a resolution less than the current image or video resolution.

Example 15 can include or use, or can optionally be combined with the subject matter of at least one of Examples 11-14 to include or use periodically determining, using the DPMM, whether at least one of the compute bandwidth or the RSS meets or exceeds the execution requirements of the first application segment for a current image or video resolution, and determining, using the DPMM and in response to determining the compute bandwidth and the RSS, whether to increase, decrease, or not change the resolution of an image or video used by the first application segment based on the determined compute bandwidth and the RSS.

Example 16 can include or use subject matter (such as an apparatus, a method, a means for performing acts, or a machine readable medium including instructions that, when performed by the machine, can cause the device to perform operations), such as can include or use determining a segmented application has launched, the segmented application including a first application segment comprising executable code stored locally to be executed by a local processor and a second application segment comprising a stub that when activated directs the local processor to a location where at least one output variable of the second application segment is stored, wherein execution of the first application segment depends on the at least one output variable of the second application segment, in response to determining the segmented application has launched, determining one or more execution parameters of the at least one processor, at least one local memory device, and a network interface device, determining whether to handover execution of the first application segment to a processing device based on the determined execution parameters, and determining whether to request to take over execution of the second application segment based on the determined execution parameters.

Example 17 can include or use, or can optionally be combined with the subject matter of Example 16 to include or use, wherein the execution parameters include available RAM of a first memory of the at least one memory, available ROM of a second memory of the at least one memory, available compute bandwidth of the at least one processor, and the RSS at the network interface device, and the instructions further comprise instructions which, when executed by the machine, cause the machine to perform operation comprising comparing the determined execution parameters to respective RAM, ROM, compute bandwidth, and RSS required for execution of the first application segment to determine whether to handover over execution of the first application segment to the processing device or retain execution of the first application segment.

Example 18 can include or use, or can optionally be combined with the subject matter of at least one of Examples 16-17 to include or use, wherein the instructions for determining the one or more execution parameters of the at least one processor, at least one local memory device, and a network interface device, include instructions for determining the one or more execution parameters periodically, and the instructions further comprise instructions for determining whether to handover execution of the first application segment to a processing device based on the determined execution parameters includes determining whether to handover execution of the first application segment in response to determining the one or more execution parameters, and determining whether to request to take over execution of the second application segment based on the determined execution parameters includes determining whether to request to take over execution of the second application segment in response to determining the one or more execution parameters.

Example 19 can include or use, or can optionally be combined with the subject matter of at least one of Examples 16-18 to include or use determining that at least one of the compute bandwidth or the RSS does not meet the execution requirements of the first application segment for a current image or video resolution, determining whether the image or video resolution is currently minimized, and providing an indication to the processing circuitry that causes the at least one processor to execute the first application segment using an image or video with a resolution less than the current image or video resolution.

Example 20 can include or use, or can optionally be combined with the subject matter of at least one of Examples 16-19 to include or use periodically determining whether at least one of the compute bandwidth or the RSS meets or exceeds the execution requirements of the first application segment for a current image or video resolution, and determining, in response to determining the compute bandwidth and the RSS, whether to increase, decrease, or not change the resolution of an image or video used by the first application segment based on the determined compute bandwidth and the RSS.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. An apparatus comprising:
at least one processor, at least one memory device, and at least one network interface module; and
a segmented application stored in the at least one memory device and executable by the at least one processor, wherein the segmented application includes a first application segment comprising executable code stored locally to be executed by the at least one processor and a second application segment comprising a stub that when activated directs the processor to a location where at least one output variable of the second application segment is stored, wherein execution of the first application segment depends on the at least one output variable of the second application segment.

2. The apparatus of claim 1, further comprising:
a network interface device coupled to the at least one processor; and
data and processing management module (DPMM) coupled to the at least one processor, the DPMM determines one or more execution parameters of the at least one processor, the at least one memory device, and the network interface device and determines whether to handover execution of the first application segment to a processing device and whether to request to take over execution of the second application segment based on the determined execution parameters.

3. The apparatus of claim 2, wherein the execution parameters include available RAM of a first memory of the at least one memory, available ROM of a second memory of the at least one memory, available compute bandwidth of the at least one processor, and the RSS at the network interface device, and compares them to respective RAM, ROM, compute bandwidth, and RSS required for execution of the first application segment to determine whether to handover over execution of the first application segment to the processing device or retain execution of the first application segment.

4. The apparatus of claim 2, wherein:
the execution parameters include available RAM of a first memory of the at least one memory, available ROM of a second memory of the at least one memory, compute bandwidth of the at least one processor, and the RSS at the network interface device,
the network interface device provides the determined execution parameters to the processing device, and
the network interface device receives a request to handover execution of the first application segment to the processing device.

5. The apparatus of claim 2, wherein:
the execution parameters include available RAM of a first memory of the at least one memory, available ROM of a second memory of the at least one memory, compute bandwidth of the at least one processor, and the RSS at the network interface device,
the network interface device provides the determined execution parameters to the processing device, and
the network interface device receives a request to handover execution of the second application segment to the apparatus.

6. The apparatus of claim 2, wherein:
the DPMM determines that at least one of the compute bandwidth or the RSS does not meet the execution requirements of the first application segment,
the DPMM determines whether the resolution of an image or video is currently minimized, and
the DPMM provides an indication to the at least one processor that causes the produce to reduce a resolution of an image or video upload or download in response to determining that at least one of the compute bandwidth and the RSS does not meet the execution requirements of the first application segment and determining that the resolution of the image or video is currently not minimized.

7. The apparatus of claim 2, wherein:
the DPMM determines that the RSS does not meet the execution requirements of the first application segment, and
the DPMM provides an indication to the at least one processor that causes the processor to begin storing deltas in a cache of the at least one memory for transmission to the processing device after the RSS is determined by the DPMM to meet the execution requirements.

8. The apparatus of claim 2, wherein:
the DPMM determines the execution parameters periodically and determines whether to request to handover execution of the first application segment to the processing device in response to determining the execution parameters.

9. The apparatus of claim 2, wherein:
the at least one memory includes at least one image or video of the first application segment thereon,
the DPMM determines whether the resolution of the image or video stored on the at least one memory is maximized, and
the DPMM requests a higher resolution version of the image or video from the processing device in response to determining the resolution of the image or video stored on the at least one memory is not maximized and the execution parameters are sufficient for the resolution.

10. The apparatus of claim 2, wherein the DPMM determines the compute bandwidth and the RSS periodically and determines whether to increase or decrease the resolution of an image or video based on the determined compute bandwidth and the RSS and in response to determining the compute bandwidth and the RSS.

11. A method comprising:
determining, using processing circuitry, a segmented application has launched, the segmented application including a first application segment comprising executable code stored locally to be executed by a local processor and a second application segment comprising a stub that when activated directs the local processor to a location where at least one output variable of the second application segment is stored, wherein execution of the first application segment depends on the at least one output variable of the second application segment;
in response to determining the segmented application has launched, determining, using a data and processing management module executable by the processing circuitry, one or more execution parameters of the at least one processor, at least one local memory device, and a network interface device;
determining whether to handover execution of the first application segment to a processing device based on the determined execution parameters; and
determining whether to request to take over execution of the second application segment based on the determined execution parameters.

12. The method of claim 11, wherein the execution parameters include available RAM of a first memory of the at least one memory, available ROM of a second memory of the at least one memory, available compute bandwidth of the at least one processor, and the RSS at the network interface device, and the method further comprises; and
comparing the determined execution parameters to respective RAM, ROM, compute bandwidth, and RSS required for execution of the first application segment to determine whether to handover over execution of the first application segment to the processing device or retain execution of the first application segment.

13. The method of claim 11, wherein:
determining the one or more execution parameters of the processing circuitry, at least one local memory device, and a network interface device, includes determine the one or more execution parameters periodically;
determining whether to handover execution of the first application segment to a processing device based on the determined execution parameters includes determining whether to handover execution of the first application segment in response to determining the one or more execution parameters; and
determining whether to request to take over execution of the second application segment based on the determined execution parameters includes determining whether to request to take over execution of the second application segment in response to determining the one or more execution parameters.

14. The method of claim 11, further comprising:
determining, using the DPMM, that at least one of the compute bandwidth or the RSS does not meet the execution requirements of the first application segment for a current image or video resolution,
determining, using the DPMM, whether the image or video resolution is currently minimized, and
providing, using the DPMM, an indication to the processing circuitry that causes the processing circuitry to execute the first application segment using an image or video with a resolution less than the current image or video resolution.

15. The method of claim 11, further comprising:
periodically determining, using the DPMM, whether at least one of the compute bandwidth or the RSS meets or exceeds the execution requirements of the first application segment for a current image or video resolution; and
determining, using the DPMM and in response to determining the compute bandwidth and the RSS, whether to increase, decrease, or not change the resolution of an image or video used by the first application segment based on the determined compute bandwidth and the RSS.

16. A machine-readable storage device comprising instructions stored thereon that, when executed by a machine, cause the machine to perform operations comprising:
determining a segmented application has launched, the segmented application including a first application segment comprising executable code stored locally to be executed by a local processor and a second application segment comprising a stub that when activated directs the local processor to a location where at least one output variable of the second application segment is stored, wherein execution of the first application segment depends on the at least one output variable of the second application segment;
in response to determining the segmented application has launched, determining one or more execution parameters of the at least one processor, at least one local memory device, and a network interface device;
determining whether to handover execution of the first application segment to a processing device based on the determined execution parameters; and
determining whether to request to take over execution of the second application segment based on the determined execution parameters.

17. The storage device of claim 16, wherein the execution parameters include available RAM of a first memory of the at least one memory, available ROM of a second memory of the at least one memory, available compute bandwidth of the at least one processor, and the RSS at the network interface device, and the instructions further comprise instructions which, when executed by the machine, cause the machine to perform operation comprising comparing the determined execution parameters to respective RAM, ROM, compute bandwidth, and RSS required for execution of the first application segment to determine whether to handover over execution of the first application segment to the processing device or retain execution of the first application segment.

18. The storage device of claim 16, wherein the instructions for determining the one or more execution parameters of the at least one processor, at least one local memory device, and a network interface device, include instructions for determining the one or more execution parameters periodically, and the instructions further comprise instructions for determining whether to handover execution of the first application segment to a processing device based on the determined execution parameters includes determining whether to handover execution of the first application segment in response to determining the one or more execution parameters, and determining whether to request to take over execution of the second application segment based on the determined execution parameters includes determining whether to request to take over execution of the second application segment in response to determining the one or more execution parameters.

19. The storage device of claim 16, further comprising instructions which, when executed by the machine, cause the machine to perform operations comprising:
determining that at least one of the compute bandwidth or the RSS does not meet the execution requirements of the first application segment for a current image or video resolution, determining whether the image or video resolution is currently minimized, and
providing an indication to the processing circuitry that causes the at least one processor to execute the first application segment using an image or video with a resolution less than the current image or video resolution.

20. The storage device of claim 16, further comprising instructions which, when executed by the machine, cause the machine to perform operations further comprising:
periodically determining whether at least one of the compute bandwidth or the RSS meets or exceeds the execution requirements of the first application segment for a current image or video resolution; and
determining, in response to determining the compute bandwidth and the RSS, whether to increase, decrease, or not change the resolution of an image or video used by the first application segment based on the determined compute bandwidth and the RSS.
